(19) United States
(12) Patent Application Publication
(10) Pub. No.: US 2025/0384657 A1
(43) Pub. Date: Dec. 18, 2025

(54) FEATURE COMPARISON DEVICE, AND FEATURE COMPARISON METHOD

(71) Applicant: NEC Corporation, Tokyo (JP)

(72) Inventor: Mizuho KATAYAMA, Tokyo (JP)

(73) Assignee: NEC Corporation, Tokyo (JP)

(21) Appl. No.: 19/232,983

(22) Filed: Jun. 10, 2025

(30) Foreign Application Priority Data
Jun. 17, 2024 (JP) 2024-097129

(51) Int. Cl. G06V 10/75; G06V 10/25; G06V 10/32; G06V 10/62; G06V 10/74

(52) U.S. Cl. CPC G06V 10/757; G06V 10/25; G06V 10/32; G06V 10/62; G06V 10/761

(57) ABSTRACT

The feature comparison device includes: a calculation unit configured to calculate Gram matrices for each of a feature value of target data and a feature value of past data acquired before the target data, and to perform a calculation to normalize the norm of a difference between the Gram matrices; a comparison unit configured to compare the target data with the past data based on a result of the calculation; and an output unit configured to output a result of the comparison.

This application is based upon and claims the benefit of priority from the prior Japanese Patent Application No. 2024-097129, filed Jun. 17, 2024, the entire contents of which are incorporated herein by reference.

### BACKGROUND OF INVENTION

### Field of the Invention

This present disclosure relates to a feature comparison device, a feature comparison method, and a feature comparison program.

### Description of the Related Art

As technology related to the comparison of feature values, for example, Non-patent literature 1 describes a method for comparing feature values using CKA (Centered Kernel Alignment, an inner product).
[Non-patent literature 1] Simon Kornblith, Mohammad Norouzi, Honglak Lee, Geoffrey Hinton, “Similarity of Neural Network Representations Revisited”, Available at: https://arxiv.org/pdf/1905.00414.pdf, accessed on Jun. 11, 2024.

### SUMMARY OF INVENTION

However, the method described in Non-patent literature 1 still leaves room for improvement in the comparison accuracy of feature values.

One of the purposes of this invention is to provide a feature comparison device, a feature comparison method, and a feature comparison program that can enhance the comparison accuracy of feature values.

The feature comparison device according to the present disclosure includes: a calculation unit configured to calculate Gram matrices for each of a feature value of target data and a feature value of past data acquired before the target data, and to perform a calculation to normalize the norm of a difference between the Gram matrices; a comparison unit configured to compare the target data with the past data based on a result of the calculation; and an output unit configured to output a result of the comparison.

The feature comparison method performed by a computer according to the present disclosure includes: calculating Gram matrices for each of a feature value of target data and a feature value of past data acquired before the target data, and performing a calculation to normalize the norm of a difference between the Gram matrices; comparing the target data with the past data based on a result of the calculation; and outputting a result of the comparison.

The feature comparison program according to the present disclosure is a program that, when executed by a computer, performs: calculating Gram matrices for each of a feature value of target data and a feature value of past data acquired before the target data, and performing a calculation to normalize the norm of a difference between the Gram matrices; comparing the target data with the past data based on a result of the calculation; and outputting a result of the comparison.

According to the present disclosure, it is possible to enhance the comparison accuracy of feature values.

### BRIEF DESCRIPTION OF THE DRAWINGS

FIG. 1 It depicts a block diagram illustrating an example functional configuration of a feature comparison device.

FIG. 2A It depicts a diagram illustrating an example of the n-th frame image.

FIG. 2B It depicts a diagram illustrating an example of the (n+1)-th frame image.

FIG. 2C It depicts a diagram illustrating an example of the (n+2)-th frame image.

FIG. 2D It depicts an explanatory diagram illustrating simulation results obtained by applying, respectively, a feature comparison method of the present disclosure and a comparison method that uses CKA.

FIG. 3 It depicts a flowchart illustrating an example operation of the feature comparison device.

FIG. 4 It depicts an explanatory diagram illustrating an overview of the operation of the feature comparison device.

FIG. 5 It depicts a block diagram illustrating another example functional configuration of the feature comparison device.

FIG. 6 It depicts an explanatory diagram illustrating another overview of the operation of the feature comparison device.

FIG. 7 It depicts a flowchart illustrating an example operation of a system to which the feature comparison device is applied.

FIG. 8 It depicts a block diagram illustrating a configuration of a computer.

FIG. 9 It depicts a block diagram illustrating main components of the feature comparison device.

### DESCRIPTION OF THE PREFERRED EMBODIMENTS

Below, example embodiments of the present disclosure will be explained with reference to the drawings. In each drawing, the same or corresponding elements are assigned the same reference numerals, and for the sake of clarity of explanation, redundant explanation may be omitted as necessary. Unless otherwise explained, predetermined values such as a specified value or threshold are pre-stored in a storage device accessible from the device that uses those values. Also, unless otherwise explained, the storage unit is composed of one or more arbitrary numbers of storage devices.

### Example Embodiment 1

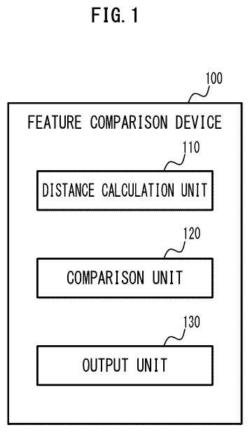

The functional configuration of a feature comparison device in a first example embodiment will be explained. FIG. 1 is an explanatory diagram that is a block diagram exemplifying the functional configuration of the feature comparison device. The feature comparison device 100 of the present example embodiment includes a distance calculation unit 110, a comparison unit 120, and an output unit 130.

The distance calculation unit 110 has a function to calculate the distance between a feature value of target data and a feature value of past data acquired before the target data. The distance calculation unit 110, for each of the feature values of target data and past data, calculates a Gram matrix and performs a calculation to normalize the norm of the difference. The distance calculation unit 110 obtains, for example, the Frobenius norm of the matrix as the norm of the matrix. However, the type of matrix norm that the distance calculation unit 110 can use is not limited to the Frobenius norm.

When performing normalization, the distance calculation unit 110 uses a sum of the Frobenius norms of each Gram matrix as a denominator of a normalization term. Note that the distance calculation unit 110 can use a normalization term used during normalization for first target data in normalization for second target data acquired after the first target data.

The target data and past data are, for example, image data or data corresponding to an image. Data corresponding to an image is, for example, data derived by performing a predetermined process on an image. Such predetermined process is, for example, a process of extracting abstract information such as feature values from the image.

The target data and the past data are, for example, image data or data corresponding to an image, which are consecutive in a time series. That is, the target data and the past data are, for example, frame images, which are continuous in time series among multiple frame images constituting a moving image.

The target data is, for example, data corresponding to a region in an image in which an object is detected. Also, the past data is, for example, data corresponding to a region in an image acquired before the image in which the same object is detected. That is, the target data is, for example, data corresponding to a region where an object is detected by an object detection process in an n-th frame image. In that case, the past data is, for example, data corresponding to a region where the same object is detected by the object detection process in an (n−1)-th frame image acquired before the n-th frame image.

The comparison unit 120 has a function to compare the target data with the past data based on a result of the calculation from the distance calculation unit 110. For example, when the result of the calculation from the distance calculation unit 110 is equal to or greater than a predetermined threshold (that is, when the distance is large), the comparison unit 120 determines that the target data is dissimilar to the past data. Also, when the result of the calculation from the distance calculation unit 110 is less than the predetermined threshold (that is, when the distance is small), the comparison unit 120 determines that the target data is similar to the past data. Note that, for the predetermined threshold used for comparison with the result of the calculation, a user can set an arbitrary value, for example.

The output unit 130 has a function to output a result of the comparison from the comparison unit 120. For example, the output unit 130 outputs and stores information indicating the result of the comparison from the comparison unit 120 in a storage unit (not shown) of the feature comparison device 100 or an external device. Also, for example, the output unit 130 outputs and displays information indicating the result of the comparison from the comparison unit 120 to a display device (not shown). As information indicating the result of the comparison from the comparison unit 120, the output unit 130 may output, for example, information indicating that the target data is dissimilar to the past data, or information indicating that the target data is similar to the past data.

Next, the details of the calculation performed by the distance calculation unit 110 will be explained. For simplicity, assume that the images to be compared are I₁ and I₂ shown in Equation (1).

$$[ Math . 1 ]$$

$${I}_{1} ∈ {ℝ}^{{H}_{1} \times {W}_{1} \times C} , {I}_{2} ∈ {ℝ}^{{H}_{2} \times {W}_{2} \times C} \qquad Equation ( 1 )$$

X and Y shown in Equation (2) are matrices in which images I₁ and I₂ are each sliced horizontally in parallel and arranged side by side.

$$[ Math . 2 ]$$

$$X ∈ {ℝ}^{C \times {H}_{1} {W}_{1}} , Y ∈ {ℝ}^{{ℝ}^{C \times {H}_{2} {W}_{2}}} \qquad Equation ( 2 )$$

As shown in Equation (3), the distance calculation unit 110 calculates the Gram matrix of each matrix and performs a calculation to normalize the norm of the difference.

$$[ Math . 3 ]$$

$$\frac{{‖ {XX}^{T} - {YY}^{T} ‖}_{F}}{{‖ {XX}^{T} ‖}_{F} + {‖ {YY}^{T} ‖}_{F}} \qquad Equation ( 3 )$$

Assume a case where the images to be compared are RGB images with C=3. In this case, the matrix X and the Gram matrix XX^{T} become as shown in Equation (4).

$$[ Math . 4 ]$$

$$X = [ \begin{matrix}\vec{r} \\ \vec{g} \\ \vec{b}\end{matrix} ] , \vec{r} , \vec{g} , \vec{b} ∈ {ℝ}^{{H}_{1} {W}_{1}} ( \vec{r} , \vec{g} , and \vec{b} are horizontal vectors ) \qquad Equation ( 4 )$$

$${XX}^{T} = [ \begin{matrix}\vec{r} \cdot \vec{r} & \vec{r} \cdot \vec{g} & \vec{r} \cdot \vec{b} \\ \vec{g} \cdot \vec{r} & \vec{g} \cdot \vec{g} & \vec{g} \cdot \vec{b} \\ \vec{b} \cdot \vec{r} & \vec{b} \cdot \vec{g} & \vec{b} \cdot \vec{b}\end{matrix} ]$$

In Equation (4), multiplying the same row vectors such as r·r corresponds to the sum of squares of the same color components. Also, multiplying different row vectors such as r g calculates the correlation between different colors. In other words, XX^{T} is a matrix that stores the sum of squares of the pixel values of the image. YY^{T} is likewise a matrix that stores the sum of squares of the pixel values of the image. Note that, when the image is monochrome, C=1. Therefore, XX^{T} has a single element, and that element is the sum of squares of all pixel values.

Note also that the distance calculation unit 110 calculates the Frobenius norm for XX^{T}. That is, the distance calculation unit 110 can be said to calculate the square root of the sum of squares of a matrix that stores the sum of squares of the pixel values of the image.

As shown in Equation (3), the numerator of the calculation formula used by the distance calculation unit 110 is simple: it calculates the sum of squares of pixel values for each of the images to be compared and takes their difference.

Also, as shown in Equation (3), the denominator of the calculation formula used by the distance calculation unit 110 is the sum of the Frobenius norms of each Gram matrix. That is, the denominator of the calculation formula shown in Equation (3) is the sum of the Frobenius norm of XX^{T} and the Frobenius norm of YY^{T}. As shown in Equation (3), the distance calculation unit 110 performs normalization by using the sum of the Frobenius norms of each Gram matrix as the denominator of the normalization term.

By using the calculation formula shown in Equation (3), the distance calculation unit 110 can perform a comparative calculation for X and Y as matrices even when the spatial sizes of the images differ from each other.

Next, a typical method of comparing feature values that uses CKA (Centered Kernel Alignment, inner product) will be explained. CKA is one of the methods for measuring similarity between two datasets or two feature vectors.

There are multiple variations of CKA. In one variation, the calculation formula of Equation (5) is used. Below, CKA using the calculation formula of Equation (5) will be explained.

$$[ Math . 5 ]$$

$$\frac{{‖ {Y}^{T} X ‖}_{F}^{2}}{{‖ {X}^{T} X ‖}_{F} {‖ {Y}^{T} Y ‖}_{F}} \qquad Equation ( 5 )$$

Assume a case where the images to be compared are RGB images with C=3. Each variable is defined as shown in Equation (6).

$$[ Math . 6 ]$$

$$X = [ \begin{matrix}\vec{{x}^{r}} \\ \vec{{x}^{g}} \\ \vec{{x}^{b}}\end{matrix} ] , \vec{{x}^{r}} , \vec{{x}^{g}} , \vec{{x}^{b}} ∈ {ℝ}^{{H}_{1} {W}_{1}} ( \vec{{x}^{r}} , \vec{{x}^{g}} , and \vec{{x}^{b}} are horizontal vectors ) \qquad Equation ( 6 )$$

Then, the numerator of CKA becomes as shown in Equation (7).

$$[ Math . 7 ]$$

$$\frac{{‖ {Y}^{T} X ‖}_{F}^{2}}{{‖ {X}^{T} X ‖}_{F} {‖ {Y}^{T} Y ‖}_{F}} \qquad Equation ( 7 )$$

$${Y}^{T} X = [ \begin{matrix}{\sum }_{c ∈ \{ r , g , b \}} {y}_{1}^{c} {x}_{1}^{c} & … & {\sum }_{c ∈ \{ r , g , b \}} {y}_{1}^{c} {x}_{{H}_{1} {W}_{1}}^{c} \\ ⋮ & ⋱ & ⋮ \\ {\sum }_{c ∈ \{ r , g , b \}} {y}_{{H}_{2} {W}_{2}}^{c} {x}_{1}^{c} & … & {\sum }_{c ∈ \{ r , g , b \}} {y}_{{H}_{2} {W}_{2}}^{c} {x}_{{H}_{1} {W}_{1}}^{c}\end{matrix} ] ∈ {ℝ}^{{H}_{2} {W}_{2} \times {H}_{1} {W}_{1}}$$

$${\sum }_{c ∈ \{ r , g , b \}} {y}_{j}^{c} {x}_{j}^{c}$$

is the channel-wise sum of the product of the i-th element of the image of y and the j-th element of the image of x

In Equation (7), looking at the first row of Y^{T}X, for y₁, the products with x₁, . . . , x_{H1W1} are each calculated. Also, a certain part of image Y is having its correlation calculated with the entirety of image X. Therefore, Y^{T}X represents the relationship between the information on which positions in Y have which values and the information on which positions in X have which values.

That is, in the method that uses CKA, the calculation result includes the spatial information of X and Y. On the other hand, in the calculation formula shown in Equation (3), which the distance calculation unit 110 uses, the term XX^{T}−YY^{T} calculates the sum of squares of pixel values in each of X and Y and calculates their difference. Therefore, in the comparison method according to the present disclosure, the spatial information of X and Y has already disappeared by the time X and Y are compared. Note that the comparison method according to the present disclosure is the method of calculating the distance of feature values using the calculation formula shown in Equation (3).

In this way, the calculation formula shown in Equation (3) used by the distance calculation unit 110 can obtain a value with fewer calculations than the calculation formula shown in Equation (5) used by CKA. Therefore, in the comparison method according to the present disclosure, compared to the general comparison method that uses CKA, it is possible to reduce processing load and increase processing speed. In addition, the comparison method according to the present disclosure can reduce power consumption.

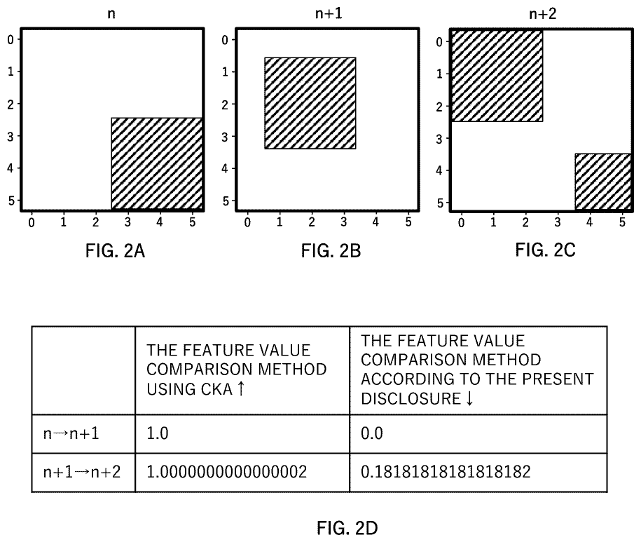

Next, the case where each of the feature value comparison methods, namely the comparison method using the feature values according to the present disclosure and the comparison method using CKA, are respectively applied will be explained. FIG. 2 is an explanatory diagram showing the simulation results obtained by applying the feature value comparison method according to the present disclosure and the feature value comparison method using CKA, respectively.

FIG. 2 shows that a n-th frame image, a (n+1)-th frame image, and a (n+2)-th frame image, which consecutive in a time series, are present. Specifically, FIG. 2A shows the n-th frame image. FIG. 2B shows the (n+1)-th frame image. FIG. 2C shows the (n+2)-th frame image.

An information processing device such as a computer compares the n-th frame image and the (n+1)-th frame image using each comparison method. Also, the information processing device compares the (n+1)-th frame image and the (n+2)-th frame image using each comparison method. From the features of each frame image shown in FIG. 2A, FIG. 2B, and FIG. 2C, it is desirable that the n-th frame image and the (n+1)-th frame image be determined as similar (that is, there is no change exceeding a predetermined threshold). In addition, it is desirable that the (n+1)-th frame image and the (n+2)-th frame image be determined as dissimilar (that is, there is a change exceeding a predetermined threshold).

FIG. 2D shows the results obtained by the information processing device when comparing the frame images using each comparison method. Note that the value calculated by the comparison method using CKA (that is, the value calculated using the calculation formula shown in Equation (5)) indicates a higher degree of similarity the closer it is to 1, and a lower degree of similarity the closer it is to 0. Meanwhile, the value calculated by the comparison method according to the present disclosure (that is, the value calculated using the calculation formula shown in Equation (3)) indicates a lower degree of similarity the closer it is to 1, and a higher degree of similarity the closer it is to 0.

The value calculated as a result of comparing the n-th frame image and the (n+1)-th frame image by the comparison method using CKA is “1.0”. Also, the value calculated as a result of comparing the n-th frame image and the (n+1)-th frame image by the comparison method according to the present disclosure is “0.0”. Therefore, regardless of which comparison method is used, it is determined that the n-th frame image and the (n+1)-th frame image have high similarity.

The value calculated as a result of comparing the (n+1)-th frame image and the (n+2)-th frame image by the comparison method using CKA is “1.0000000000000002”. Meanwhile, the value calculated as a result of comparing the (n+1)-th frame image and the (n+2)-th frame image by the comparison method according to the present disclosure is “0.18181818181818182”. That is, in the comparison method using CKA, there is no practical change in the value. Therefore, it is determined that the (n+1)-th frame image and the (n+2)-th frame image have high similarity. On the other hand, in the comparison method according to the present disclosure, a practical change in the value is observed. Accordingly, when an appropriate threshold is set, it is determined that there is a change exceeding a predetermined threshold between the (n+1)-th frame image and the (n+2)-th frame image, and their similarity is low.

In this way, the comparison method according to the present disclosure provides higher accuracy in comparing images (that is, the feature values of images) than the typical comparison method that uses CKA. Note that the term “accuracy” here does not refer to the accuracy when comparing to determine whether the contents of both images being compared are identical, but rather the accuracy when roughly comparing to determine whether the contents of both images can be regarded as the same. This remains the same throughout the following explanation. For example, the image X and the image Y to be compared might not match completely in content, but the difference between them may be very small. In such a case, by setting an appropriate threshold in the comparison method according to the present disclosure, the image X and the image Y can be regarded as the same.

Moreover, because a practical change in the value is observed in the comparison method according to the present disclosure, as compared to the typical comparison method that uses CKA, it is possible to make the setting of the threshold easier.

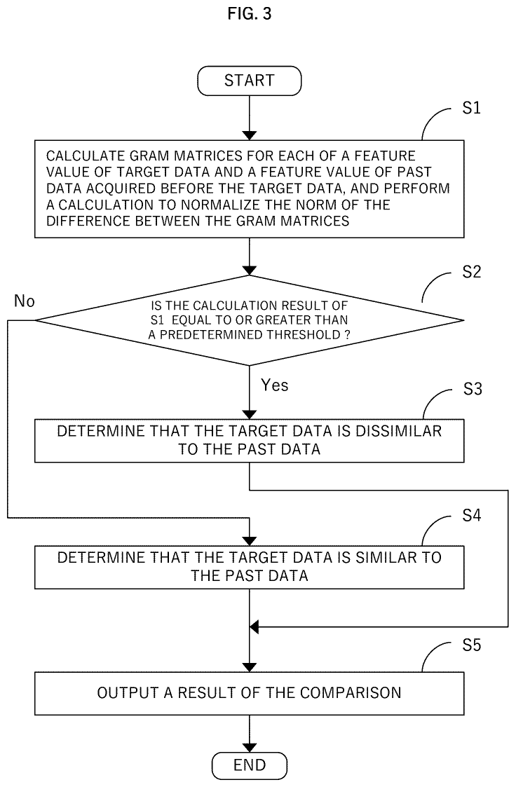

Next, the operation of the feature comparison device 100 in this example embodiment will be explained. FIG. 3 is a flowchart illustrating an example of an operation of the feature comparison device. Note that the operation example shown in FIG. 3 does not limit the operation of the feature comparison device 100 according to the present disclosure.

The distance calculation unit 110 calculates Gram matrices for each of a feature value of target data and a feature value of past data acquired before the target data, and performs a calculation to normalize the norm of the difference between the Gram matrices (step S1). For example, by using the calculation formula shown in Equation (3), the distance calculation unit 110 calculates a value that indicates the distance between the feature value of the target data and the feature value of the past data.

Next, based on a result of the calculation from the distance calculation unit 110, the comparison unit 120 compares the target data with the past data. Specifically, the comparison unit 120 determines whether the result of the calculation from the distance calculation unit 110 is equal to or greater than a predetermined threshold (step S2).

When the result of the calculation is equal to or greater than the predetermined threshold (Yes in step S2), the comparison unit 120 determines that the target data is dissimilar to the past data (step S3). After that, the process moves to step S5.

When the result of the calculation is not greater than or equal to the predetermined threshold (No in step S2), the comparison unit 120 determines that the target data is similar to the past data (step S4). After that, the process moves to step S5.

In step S5, the output unit 130 outputs a result of the comparison from the comparison unit 120 (step S5).

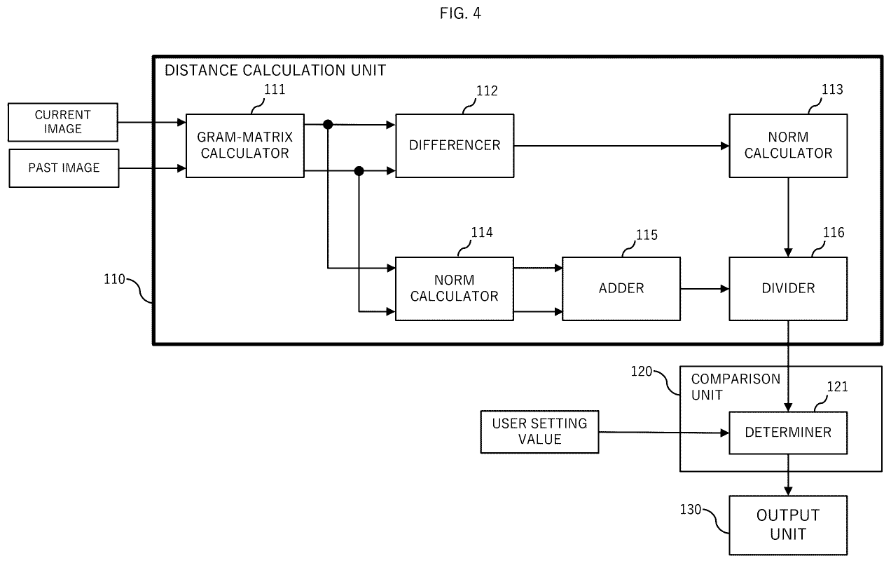

Next, the operational overview of the feature comparison device 100 in this example embodiment will be explained. FIG. 4 is an explanatory diagram that is an overview of an operation of the feature comparison device 100. Note that FIG. 4 is an explanatory diagram provided to facilitate understanding of the operational overview of the feature comparison device 100. Therefore, neither the configuration nor the operation of the feature comparison device 100 is limited to what is shown in FIG. 4. Also, while the arrows in FIG. 4 briefly indicate the flow direction of signals (data), this does not exclude bidirectionality.

As shown in FIG. 4, the distance calculation unit 110 includes a Gram-matrix calculator 111, a differencer 112, a norm calculator 113, a norm calculator 114, an adder 115, and a divider 116. Also, as shown in FIG. 4, the comparison unit 120 includes a determiner 121.

In the example shown in FIG. 4, the distance calculation unit 110 takes as input a current image and a past image for which the distance of feature values is to be calculated. The current image and the past image are, for example, frame images that are consecutive in a time series.

The distance calculation unit 110 calculates the distance between a feature value of the current image and a feature value of the past image. Note that the feature values of each image are, for example, extracted in advance by an object detector or the like.

The Gram-matrix calculator 111 calculates the Gram matrix of the feature value of the current image. Also, the Gram-matrix calculator 111 calculates the Gram matrix of the feature value of the past image. Then, the Gram-matrix calculator 111 outputs the two calculated Gram matrices respectively to the differencer 112 and the norm calculator 114.

The differencer 112 calculates the difference between the two Gram matrices calculated by the Gram-matrix calculator 111. Then, the differencer 112 outputs the calculation result to the norm calculator 113.

The norm calculator 113 calculates the Frobenius norm of the calculation result from the differencer 112 (that is, the difference of the two Gram matrices). Then, the norm calculator 113 outputs the calculation result to the divider 116.

The norm calculator 114 calculates the Frobenius norm of the Gram matrix of the current image. Also, the norm calculator 114 calculates the Frobenius norm of the Gram matrix of the past image. Then, the norm calculator 114 outputs the two calculation results to the adder 115.

The adder 115 adds the two calculation results from the norm calculator 114. That is, the adder 115 adds the Frobenius norm of the Gram matrix of the current image and the Frobenius norm of the Gram matrix of the past image. Then, the adder 115 outputs the calculation result to the divider 116.

The divider 116 divides the calculation result from the norm calculator 113 by the calculation result from the adder 115. Then, the divider 116 outputs the calculation result to the comparison unit 120.

By using the Gram-matrix calculator 111, the differencer 112, the norm calculator 113, the norm calculator 114, the adder 115, and the divider 116, the distance calculation unit 110 executes the above-mentioned processes. By executing these processes, the distance calculation unit 110 calculates the value that indicates the distance between the feature value of the target data and the feature value of the past data using the calculation formula shown in Equation (3).

Based on the calculation result from the distance calculation unit 110, the comparison unit 120 compares the current image and the past image. Specifically, the determiner 121 in the comparison unit 120 determines that the current image is dissimilar to the past image when the calculation result from the distance calculation unit 110 is greater than or equal to a predetermined threshold. Also, the determiner 121 determines that the current image is similar to the past image when the calculation result from the distance calculation unit 110 is less than the predetermined threshold. The user can set, for example by operating a user terminal such as a personal computer, a user setting value used by the determiner 121 in the comparison unit 120. The set user setting value is used as a threshold for comparison with the value calculated by the distance calculation unit 110.

The comparison unit 120 outputs the comparison result to the output unit 130. Next, the output unit 130 outputs the comparison result from the comparison unit 120.

Next, the effect of the present example embodiment will be explained. In the present example embodiment, the distance calculation unit 110 calculates Gram matrices for each of the feature values of the target data and the feature value of the past data, and performs a calculation to normalize the norm of the difference between the Gram matrices. The comparison unit 120 compares the target data with the past data based on the result of the calculation from the distance calculation unit 110. As shown in FIG. 2, the comparison method by which the distance calculation unit 110 calculates the distance using the calculation formula indicated in Equation (3) offers higher comparison accuracy for images (that is, the feature values of images) than a typical comparison method that uses CKA. With such a configuration, the feature comparison device of the present example embodiment can enhance the comparison accuracy of feature values. Note that, as described above, the “comparison accuracy” here does not refer to the accuracy when comparing to determine whether the contents of both images being compared are completely identical, but rather the accuracy when roughly comparing to determine whether the contents of both images can be regarded as the same.

Also, as shown in FIG. 2, the comparison method by which the distance calculation unit 110 calculates the distance using the calculation formula indicated in Equation (3) exhibits a practical change in its calculated value compared to a typical comparison method that uses CKA. With such a configuration, the feature comparison device of the present example embodiment can make it easier to set the threshold used in the comparison determination.

Furthermore, the calculation formula indicated in Equation (3), which is used by the distance calculation unit 110, can obtain a value with fewer calculations than the calculation formula indicated in Equation (5), which is used by CKA. With such a configuration, the feature comparison device of the present example embodiment can reduce processing load and increase processing speed. In addition, the feature comparison device of the present example embodiment can reduce power consumption.

### Example Embodiment 2

Hereinafter, the second example embodiment, which is an example embodiment of the present disclosure, will be explained in detail with reference to the drawings. For components that have the same function as those described in the first example embodiment above, the same reference numerals are assigned and their explanation is omitted as appropriate. Note that the application range of each technical means adopted in the present example embodiment is not limited to this example embodiment. That is, each technical means adopted in the present example embodiment can also be employed in other example embodiments included in the present disclosure, provided that no special technical hindrance arises. Moreover, each technical means shown in the drawings referenced to explain this example embodiment can also be adopted in other example embodiments included in the present disclosure, provided that no special technical hindrance arises.

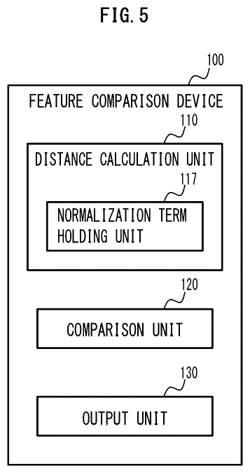

FIG. 5 is an explanatory diagram that is a block diagram illustrating the functional configuration of the feature comparison device 100. Below, the differences between the feature comparison device 100 shown in FIG. 5 and the feature comparison device 100 shown in FIG. 1 will be mainly explained, and the same parts will not be explained.

The feature comparison device 100 shown in FIG. 5 differs from the feature comparison device 100 shown in FIG. 1 in that the distance calculation unit 110 includes a normalization term holding unit 117.

For example, frame images that are consecutive in a time series. typically change in content over the passage of time. However, the denominator in Equation (3) is the sum of squares of the pixel values of each image, and it is expected that this value will not change greatly. For example, when time-series images X, Y, Z are changing over time but not changing drastically, it is assumed that the approximation in Equation (8) holds.

$$[ Math . 8 ]$$

$$C = {‖ {XX}^{T} ‖}_{F} + {‖ {YY}^{T} ‖}_{F} \approx {‖ {YY}^{T} ‖}_{F} + {‖ {ZZ}^{T} ‖}_{F} \qquad Equation ( 8 )$$

In that case, the distance calculation unit 110 can use the denominator of the normalization term in Equation (3), calculated when comparing images X and Y, for the comparison of images Y and Z. That is, the distance calculation unit 110 can use a normalization term used during normalization for first target data in normalization for second target data acquired after the first target data.

For example, the normalization term holding unit 117 stores a normalization term C from Equation (3), which was used by the distance calculation unit 110 when calculating the distance for an image Y in the (n+1)-th frame as the target data and an image X in the n-th frame as the past data. When the distance calculation unit 110 calculates the distance for an image Z in the (n+2)-th frame as the target data and the image Y in the (n+1)-th frame as the past data, it uses, as the denominator of the normalization term in Equation (3), the normalization term C stored by the normalization term holding unit 117.

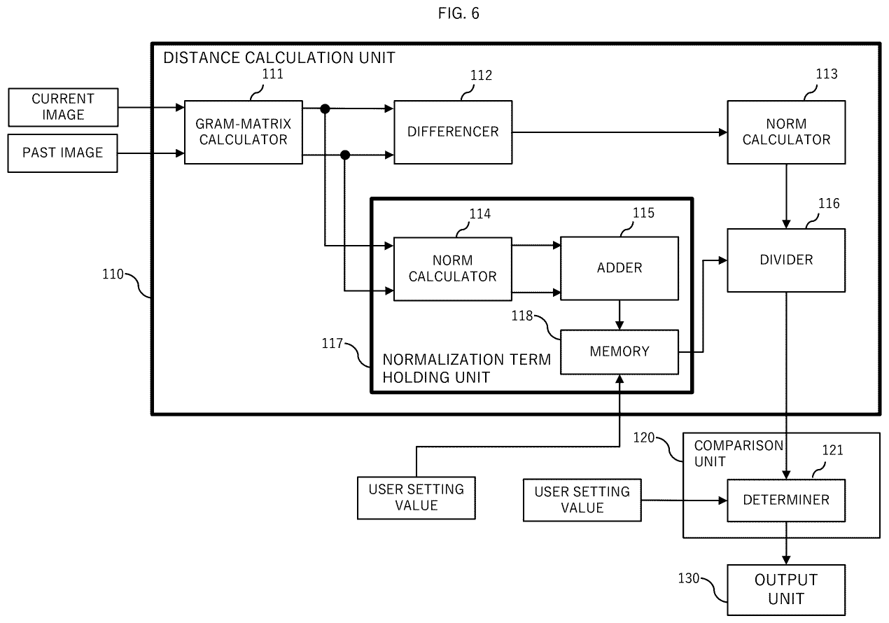

Next, an operational overview of the feature comparison device 100 in this example embodiment will be explained. FIG. 6 is an explanatory diagram that illustrates an overview of an operation of the feature comparison device 100. Note that FIG. 6 is an explanatory diagram provided to facilitate understanding of the operational overview of the feature comparison device 100. Therefore, neither the configuration nor the operation of the feature comparison device 100 is limited to what is shown in FIG. 6. Also, while the arrows in FIG. 6 briefly indicate the flow direction of signals (data), this does not exclude bidirectionality.

The distance calculation unit 110 of the feature comparison device 100 shown in FIG. 6 differs from the distance calculation unit 110 of the feature comparison device 100 shown in FIG. 4 in that it has a memory device 118. The distance calculation unit 110 shown in FIG. 6 includes a normalization term holding unit 117 having a norm calculator 114, an adder 115, and a memory device 118.

In the distance calculation unit 110 shown in FIG. 6, the adder 115 adds the two calculation results produced by the norm calculator 114. That is, the adder 115 adds the Frobenius norm of the Gram matrix of the current image and the Frobenius norm of the Gram matrix of the past image to calculate the normalization term. Then, the adder 115 respectively outputs the calculation result to a divider 116 and the memory device 118.

The memory device 118 stores the normalization term that is the calculation result of the adder 115. The memory device 118 may, for example, store the normalization term in association with the acquisition time of the current image.

When the distance calculation unit 110 calculates the distance using as the target data an image acquired after the current image shown in FIG. 6, it uses the normalization term stored by the memory device 118 of the normalization term holding unit 117. That is, the processes of the norm calculator 114 and the adder 115 are omitted.

A user can, for example, set a user setting value used by the memory device 118 by operating a user terminal. The normalization term holding unit 117 holds the normalization term based on the user setting value. The set user setting value is used, for example, as information indicating the validity period of the normalization term stored in the memory device 118 of the normalization term holding unit 117. When the validity period of the normalization term stored in the memory device 118 expires, the processes of the norm calculator 114 and the adder 115 are executed. That is, when the validity period of the normalization term set by the user expires, a new normalization term is calculated. Thus, the user can define the interval at which the normalization term is recalculated according to the situation in which the feature comparison device 100 is applied. For example, when the feature comparison device 100 inputs a moving image that changes rapidly, the user can shorten the interval at which the normalization term is recalculated.

Next, the effect of the present example embodiment will be explained. In this example embodiment, the distance calculation unit 110 includes the normalization term holding unit 117 that holds the calculated normalization term. Then, the distance calculation unit 110 uses a normalization term used during normalization for first target data in normalization for second target data acquired after the first target data. With this configuration, the feature comparison device in this example embodiment can omit the calculation of the normalization term. As a result, the feature comparison device in this example embodiment can improve processing speed.

Next, an application example of the feature comparison device 100 indicated in the first example embodiment and the second example embodiment will be explained.

As explained above, in the comparison method according to the present disclosure that uses the calculation formula indicated in Equation (3), the spatial information of X and Y disappears by the time X and Y are compared. Therefore, by using the calculation formula indicated in Equation (3), the distance calculation unit 110 of the feature comparison device 100 can roughly compare images with a small amount of calculation. For that reason, the feature comparison device 100 can be suitably applied, for example, when comparing images that are consecutive in a time series. Also, for example, the feature comparison device 100 can be suitably applied when comparing images in which the shape, color, size, or other attributes of an object are gradually changing over time. Also, for example, the feature comparison device 100 can be suitably applied when comparing images that have already been identified as the same object by tracking technology.

For example, there is an object attribute analysis system that successively inputs time-series images in sequence and executes object detection (OD) and attribute extraction (AE). Object detection processing (hereafter simply called object detection) and attribute extraction processing (hereafter simply called attribute extraction) are executed using a deep learning model. The object attribute analysis system requires real-time or faster processing speed.

In order to speed up the processing of the object attribute analysis system, one possible approach is to omit attribute extraction for the same object. When the object attribute analysis system can appropriately determine whether to omit attribute extraction, it can improve inference speed while maintaining the inference accuracy of object detection-attribute extraction.

In such an object attribute analysis system, the feature comparison device 100 of the present disclosure can be applied as a determiner that determine whether to omit attribute extraction.

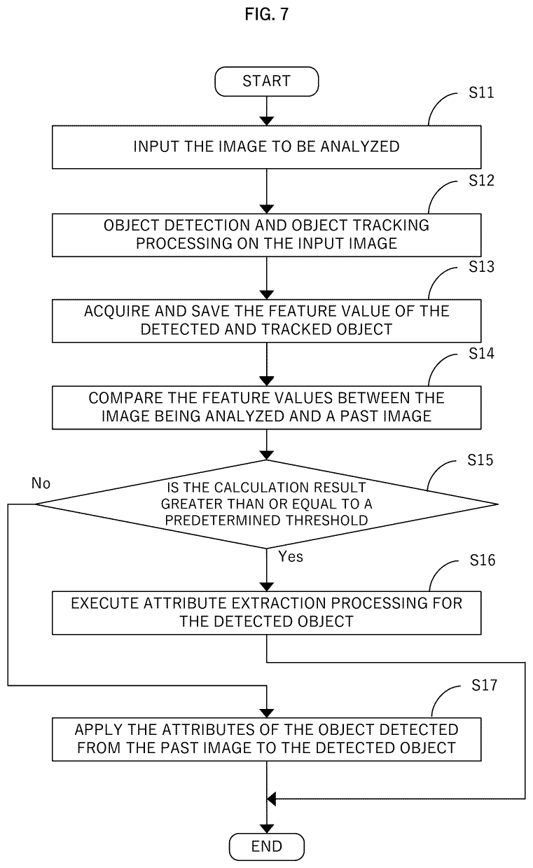

FIG. 7 is a flowchart illustrating an example of the operation of an object attribute analysis system to which the feature comparison device 100 is applied. Time-series images are successively input into the object attribute analysis system. Note that the operation example shown in FIG. 7 does not limit the operation of the feature comparison device 100 according to the present disclosure.

The object attribute analysis system inputs the image to be analyzed (step S11). Next, the object attribute analysis system performs object detection and object tracking processing on the input image (step S12). Next, the object attribute analysis system acquires and saves the feature value of the detected and tracked object (step S13).

For example, an object detector that executes object detection derives a bounding box of a detection target object in the image based on a learned model that includes multiple layers. The learned model that includes multiple layers is, for example, a deep neural network. However, the learned model is not limited to a deep neural network.

Next, in step S14, the feature comparison device 100 applied to the object attribute analysis system compares the feature values between the image being analyzed and a past image. Specifically, in step S14, the distance calculation unit 110 of the feature comparison device 100 calculates the distance between the feature values of the images using the calculation formula indicated in Equation (3).

The object detector can, for example, output data from each of the multiple layers included in its learned model. In this case, it is preferable for the feature comparison device 100 to use the data output from a layer closer to the front of the multiple layers included in the learned model. This is because the data output from a layer closer to the front generally retains spatial information comparable to that of a normal image. Also, doing so can improve the overall processing speed of the object attribute analysis system.

Next, in step S15, the comparison unit 120 of the feature comparison device 100 determines whether the calculation result from the distance calculation unit 110 is greater than or equal to a predetermined threshold.

When the calculation result from the distance calculation unit 110 is greater than or equal to the predetermined threshold (Yes in step S15), that is, when it is determined to be dissimilar to the past image, the object attribute analysis system executes attribute extraction processing for the detected object (step S16).

When the calculation result from the distance calculation unit 110 is less than the predetermined threshold (No in step S15), that is, when it is determined to be similar to the past image, the object attribute analysis system applies the attributes of the object detected from the past image to the detected object (step S17).

As shown in FIG. 7, by applying the feature comparison device 100 according to the present disclosure, the object attribute analysis system can appropriately determine whether to omit attribute extraction. As a result, the object attribute analysis system can improve inference speed while maintaining the inference accuracy of object detection-attribute extraction.

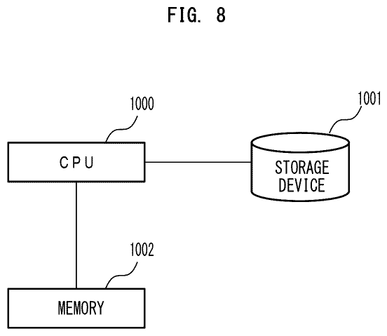

FIG. 8 is a block diagram exemplifying the configuration of a computer according to the present disclosure. The CPU 1000 implements each function of the feature comparison device 100 in the above example embodiment by executing processing in accordance with the feature comparison program stored in the storage device 1001.

That is, the CPU 1000 implements the functions of the distance calculation unit 110, the comparison unit 120, and the output unit 130 of the feature comparison device 100 shown in FIG. 1 and FIG. 5 by executing processing in accordance with the feature comparison program stored in the storage device 1001.

The storage device 1001 is, for example, a non-transitory computer readable recording medium. A non-transitory computer readable recording medium includes various types of tangible storage media. Specific examples of such non-transitory computer readable recording medium include semiconductor memory (for example, maskROM, PROM (Programmable ROM), EPROM (Erasable PROM), flashROM).

The memory 1002 is, for example, realized by RAM (Random Access Memory) and temporarily stores data when the CPU 1000 executes processing.

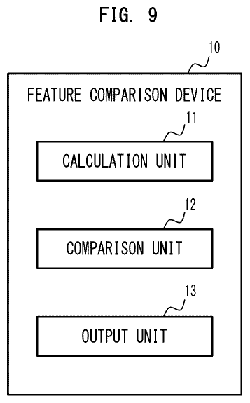

Next, the overview of the present disclosure will be explained. FIG. 9 is a block diagram exemplifying the main components of the feature comparison device. The feature comparison device 10 (for example, corresponding to the feature comparison device 100) shown in FIG. 9 includes a calculation unit 11 (in the example embodiment, realized by the distance calculation unit 110) that calculates Gram matrices for each of a feature value of target data and a feature value of past data acquired before the target data, and performs a calculation to normalize the norm of a difference between the Gram matrices, a comparison unit 12 (in the example embodiment, realized by the comparison unit 120) that compares the target data with the past data based on a result of the calculation from the calculation unit 11, and an output unit 13 (in the example embodiment, realized by the output unit 130) that outputs a result of the comparison from the comparison unit 12. With this configuration, the feature comparison device 10 can enhance the comparison accuracy of feature values. Note that, as described above, the term “comparison accuracy” here does not refer to the accuracy when comparing to determine whether the contents of both images being compared are completely identical, but rather the accuracy when roughly comparing to determine whether the contents of both images can be regarded as the same. In addition, in the feature comparison device 10, the setting of the threshold used for the comparison determination can be facilitated. Furthermore, the feature comparison device 10 can reduce processing load and increase processing speed.

As described above, the present disclosure has been explained with reference to the example embodiments, but the present disclosure is not limited to the above example embodiments. Various modifications can be made to the configuration and details of the present disclosure within the scope of the present disclosure by those skilled in the art. Each example embodiment can be combined with other example embodiments as appropriate.

Each drawing is merely an illustration for explaining one or more example embodiments. Each drawing is not necessarily associated with only one specific example embodiment, but may be associated with one or more other example embodiments. As will be understood by those skilled in the art, various features or steps explained with reference to any one drawing can be combined with the features or steps shown in one or more other drawing s to produce, for example, an embodiment not explicitly illustrated or explained. Not all features or steps shown in any one drawing for the purpose of explaining an example embodiment are necessarily indispensable, and some features or steps can be omitted. The order of steps described in any drawing can be changed as appropriate.

Some or all of the above example embodiments may also be described in the following appended statements, among others, without limitation.

(Supplementary note 1) A feature comparison device comprising:
a calculation unit that calculates Gram matrices for each of a feature value of target data and a feature value of past data acquired before the target data, and perform a calculation to normalize the norm of a difference between the Gram matrices;
a comparison unit that compares the target data with the past data based on a result of the calculation; and
an output unit that outputs a result of the comparison.
   (Supplementary note 2) The feature comparison device according to supplementary note 1, where in
the calculation unit uses a normalization term used during normalization for first target data in normalization for second target data acquired after the first target data.
   (Supplementary note 3) The feature comparison device according to supplementary note 2, further comprising:
a memory configured to store the normalization term used during normalization for the first target data based on a user-defined value set by a user,
wherein the calculation unit performs the calculation to normalize the second target data using the stored normalization term.
   (Supplementary note 4) The feature comparison device according to any one of supplementary notes 1 to 3, wherein
the calculation unit uses a sum of norms of each Gram matrix as a denominator of a normalization term during normalization.
   (Supplementary note 5) The feature comparison device according to any one of supplementary notes 1 to 4, wherein
the comparison unit determines that the target data is dissimilar to the past data when the result of the calculation is equal to or greater than a predetermined threshold.
   (Supplementary note 6) The feature comparison device according to any one of supplementary notes 1 to 5, wherein
the target data and the past data are image data or data corresponding to an image.
   (Supplementary note 7) The feature comparison device according to any one of supplementary notes 1 to 6, wherein
the target data and the past data are image data or data corresponding to an image, which are consecutive in a time series.
   (Supplementary note 8) The feature comparison device according to any one of supplementary notes 1 to 7, wherein
the target data corresponds to a region in an image in which an object is detected, and
the past data corresponds to a region in an image acquired before the image in which the object is detected.
   (Supplementary note 9) A feature comparison method performed by a computer and comprising:
calculating Gram matrices for each of a feature value of target data and a feature value of past data acquired before the target data, and performing a calculation to normalize the norm of a difference between the Gram matrices;
comparing the target data with the past data based on a result of the calculation; and
outputting a result of the comparison.
   (Supplementary note 10) A feature comparison program that, when executed by a computer, performs:
calculating Gram matrices for each of a feature value of target data and a feature value of past data acquired before the target data, and performing a calculation to normalize the norm of a difference between the Gram matrices;
comparing the target data with the past data based on a result of the calculation; and
outputting a result of the comparison.
   (Supplementary note 11) A non-transitory computer-readable recording medium storing a feature comparison program that, when executed by a computer, performs operations comprising:
calculating Gram matrices for each of a feature value of target data and a feature value of past data acquired before the target data, and performing a calculation to normalize the norm of a difference between the Gram matrices;
comparing the target data with the past data based on a result of the calculation; and
outputting a result of the comparison.

Some or all of the elements (for example, configurations and functions) described in Supplementary notes 2 to 8 that are dependent on Supplementary Note 1 may also be dependent on Supplementary notes 9, 10, and 11 in the same dependent relationship as Supplementary notes 2 to 8. Some or all of the elements described in any appended note may be applied to various types of hardware, software, storage means for recording software, systems, and methods.

1. A feature comparison device comprising:
a memory storing software instructions; and
one or more processors configured to execute the software instructions to:
calculate Gram matrices for each of a feature value of target data and a feature value of past data acquired before the target data, and perform a calculation to normalize the norm of a difference between the Gram matrices;
compare the target data with the past data based on a result of the calculation; and
output a result of the comparison.

2. The feature comparison device according to claim 1, wherein
the one or more processors use a normalization term used during normalization for first target data in normalization for second target data acquired after the first target data.

3. The feature comparison device according to claim 2, further comprising:
a memory configured to store the normalization term used during normalization for the first target data based on a user-defined value set by a user,
wherein the one or more processors perform the calculation to normalize the second target data using the stored normalization term.

4. The feature comparison device according to claim 1, wherein
the one or more processors use a sum of norms of each Gram matrix as a denominator of a normalization term during normalization.

5. The feature comparison device according to claim 1, wherein
the one or more processors determine that the target data is dissimilar to the past data when the result of the calculation is equal to or greater than a predetermined threshold.

6. The feature comparison device according to claim 1, wherein
the target data and the past data are image data or data corresponding to an image.

7. The feature comparison device according to claim 1, wherein
the target data and the past data are image data or data corresponding to an image, which are consecutive in a time series.

8. The feature comparison device according to claim 1, wherein
the target data corresponds to a region in an image in which an object is detected, and
the past data corresponds to a region in an image acquired before the image in which the object is detected.

9. A feature comparison method performed by a computer and comprising:
calculating Gram matrices for each of a feature value of target data and a feature value of past data acquired before the target data, and performing a calculation to normalize the norm of a difference between the Gram matrices;
comparing the target data with the past data based on a result of the calculation; and
outputting a result of the comparison.

10. A non-transitory computer-readable recording medium storing a feature comparison program that, when executed by a computer, performs operations comprising:
calculating Gram matrices for each of a feature value of target data and a feature value of past data acquired before the target data, and performing a calculation to normalize the norm of a difference between the Gram matrices;
comparing the target data with the past data based on a result of the calculation; and
outputting a result of the comparison.

11. The feature comparison device according to claim 2, wherein
the one or more processors use a sum of norms of each Gram matrix as a denominator of a normalization term during normalization.

12. The feature comparison device according to claim 3, wherein
the one or more processors use a sum of norms of each Gram matrix as a denominator of a normalization term during normalization.

13. The feature comparison device according to claim 2, wherein
the one or more processors determine that the target data is dissimilar to the past data when the result of the calculation is equal to or greater than a predetermined threshold.

14. The feature comparison device according to claim 3, wherein
the one or more processors determine that the target data is dissimilar to the past data when the result of the calculation is equal to or greater than a predetermined threshold.

15. The feature comparison device according to claim 4, wherein
the one or more processors determine that the target data is dissimilar to the past data when the result of the calculation is equal to or greater than a predetermined threshold.

16. The feature comparison device according to claim 2, wherein
the target data and the past data are image data or data corresponding to an image.

17. The feature comparison device according to claim 3, wherein
the target data and the past data are image data or data corresponding to an image.

18. The feature comparison device according to claim 4, wherein
the target data and the past data are image data or data corresponding to an image.

19. The feature comparison device according to claim 5, wherein
the target data and the past data are image data or data corresponding to an image.
